(19) United States
(12) Patent Application Publication
(10) Pub. No.: US 2026/0271107 A1
(43) Pub. Date: Sep. 10, 2026

(54) Automated Smartphone Unpairing Device

(71) Applicants: Benjamin J Kwitek, Colorado Springs, CO (US); Scott C Harris, Rancho Santa Fe, CA (US)

(72) Inventors: Benjamin J Kwitek, Colorado Springs, CO (US); Scott C Harris, Rancho Santa Fe, CA (US)

(21) Appl. No.: 19/072,359

(22) Filed: Mar. 6, 2025

(51) Int. Cl. H04W 76/14; H04M 1/72409; H04W 12/06

(52) U.S. Cl. CPC H04W 76/14; H04M 1/724098; H04W 12/068

(57) ABSTRACT

An installed device such as a car or tv, which has a pairing ability to communicate with a wireless user device that is remote from the installed device. A temporary pairing mode is set. In the temporary pairing mode, the installed device receiving a still-paired signal from the user device. The still paired signal indicates that the user device should remain electronically paired to the installed device, or that the user device should not remain electronically paired to the installed device. If the installed device should not be paired to the wireless user device, the installed device deletes the stored information which enables the installed device to pair with the wireless user device.

### BACKGROUND

Many people have their smartphones connected to their automobiles and other electronic devices. This allows for more functionality and convenience when driving, including the ability to take and make calls utilizing the speakers and microphones inside of the vehicle.

Some systems also allow for the smartphone's apps and data to be available on the user interface, e.g the touchscreen of the automobile. This gives the driver access to music, photos, social media and contacts from their smartphone on the touchscreen of the automobile. This is helpful and desirable.

For a personal vehicle, this pairing typically occurs when one takes delivery of the new vehicle. From that day forward, the user assumes that the pairing will occur every time they use the vehicle. The fact that contacts and music from the customer's smartphone is available or partially available through the vehicle is convenient.

Users may also pair their smartphones with other electronic devices such as televisions or videos and other consumer electronics. When the user is pairing with their own consumer electronics, there is some security from the fact that the user owns the electronics.

### SUMMARY OF THE INVENTION

The inventors have recognized, however, that there is inherent insecurity when the user pairs their smartphone, or other user device, with an electronic device that is not their own.

The inventors have recognized a need for an automatic smartphone unpairing system.

The present invention provides for the methods and systems to reduce or address this problem by providing an automatic unpairing functionality on an electronic device.

An embodiment provides a processor associated with the electronic device that senses that the electronic device is being paired with a non-home based electronic device, and provides a special kind of pairing that is specifically for the non-home based electronic device.

Another embodiment provides a processor that includes programming that allows entering a mode for rental situations, and provides a special mode of pairing with and unpairing from, electronic devices in rental situations.

### BRIEF DESCRIPTION OF THE DRAWINGS

In the Drawings:

the figure shows aspects of the invention, and specifically:

FIG. 1 shows a block diagram of a vehicle and processor; and

FIG. 2 shows a communication flow between a processor and a smartphone.

### DETAILED DESCRIPTION

Throughout this application, a vehicle may refer to an automobile, truck, bus, train, airplane or other passenger-moving device.

A “user device” refers to any electronically operated device associated with a user that is going to be wirelessly paired with another device, the “installed device”. Specifically the user devices described herein have the ability to communicate via a wireless form such as by Bluetooth, or Wi-Fi and used to authorize certain actions taken by the electronic device on the installed device.

An example of a problem being addressed by the present application occurs with rental or loaner vehicles. For example: when renting a modern car, the user often pairs their smartphone for access to use their smartphone with the car. This allows the convenience of using the user smartphone with the hardware in the vehicle, such as making calls on the vehicle microphone and speaker, and using navigation apps on the vehicle's screen. However, this often means that the user's own information, including contacts and addresses, are shared with a vehicle that is not their own.

Once paired, the user's data is then displayed on the screen of the rental vehicle. While useful during the rental period, there is a danger that the renter might forget to unpair their device when they return the vehicle.

Oftentimes when the user walks or drives away from the rental vehicle, the transmittal connection is broken. Unfortunately, some of the data might still remain on the rental vehicle—in its memory or cache. Many have experienced the situation where other peoples phones' histories are shown on the screen of the rental vehicle.

An example of how this programming could compromise privacy and security is explained via this case in point. In this example, a Hollywood agent flies into Miami. The agent rents a car and pairs the agent's smartphone with the vehicle. Then the agent later returns the vehicle. Subsequent users of the rental vehicle might see calls that were made from or to the vehicle by the agents call, such as “Kim Kardashian mobile” or “Austin Butler home” on the vehicle's screen. This information is obviously private and confidential. In the wrong hands, these numbers could be broadcast to the world, sold on the Internet or used for other criminal purposes.

The rental car companies could certainly clear this connection and any remaining memory between renters, but this has not conventionally been done. In any case, this would rely on someone doing their job properly and efficiently.

Similar occurrences happen when the user pairs their smartphone with an electronic device in other rental situations. For example, users often pair their devices with televisions in hotel rooms. In this situation, there can be even more danger, because some of the user's permissions might remain on the television allowing others to watch television shows associated with the user who has long since left the hotel room.

In this example, a user might check into a hotel room, and use their smartphone or tablet to authorize the television in the hotel to play videos based on their Netflix account. In this example scenario, the user may leave the hotel room while still allowing others who subsequently enter that same hotel room to play videos based on their Netflix credentials.

Herein, the user's device, such as a smartphone or tablet, is referred to as a “user device”. The vehicle to which the user device is pairing, is referred to herein as an “installed device” that is installed in either a vehicle, a home, or a rental situation.

An embodiment describes a user device detecting, based on circumstances, when it is being paired with non-home based electronics, in an embodiment, a non-home vehicle. Non-home vehicles refers to any vehicle that is either not entered into the database, previously paired and utilized, or cleared by the user. When a non-home vehicle is paired, the smartphone takes steps to pair the device in a temporary way, as a temporary convenience use connection.

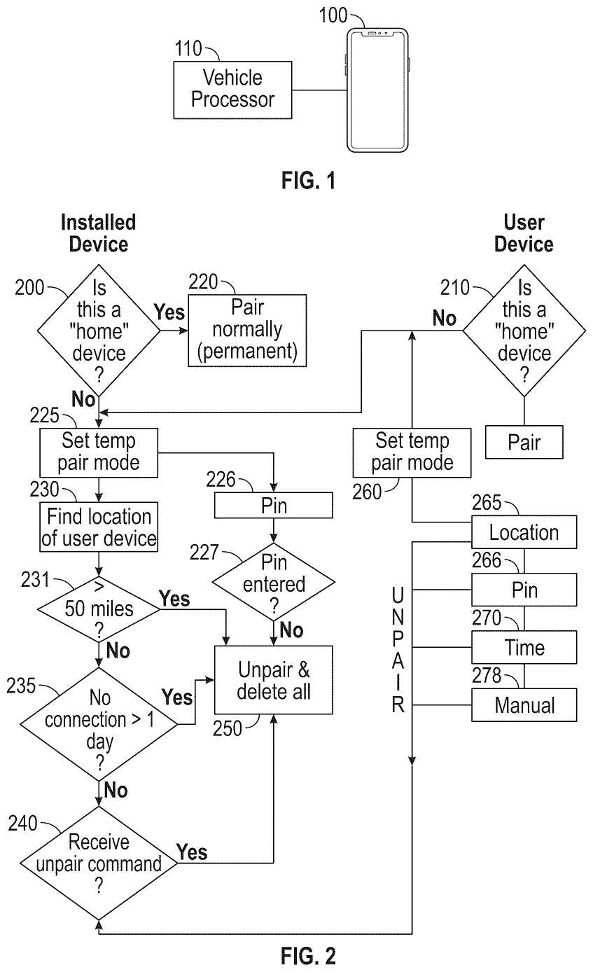

In an embodiment shown in FIG. 1, the user connects their user device, shown here as a smartphone 100, to an installed device shown here as a vehicle processor 110. Both the smartphone and the vehicle processor each have processors that run routines that operate as described herein.

In one embodiment, the smartphone and the user device may communicate via a back channel other than the channel which carries the communication.

FIG. 2 shows a flowchart of operation with the user device and the installed both carrying out functions, however it should be understood that either or both of the user device in the smartphone can carry out these functions, and also the other can carry out the function of the one. In FIG. 2, the installed device first determines whether it is a home device.

In one embodiment, the installed device can operate in various modes. This is analogous to the way that electronic devices such as televisions may have the ability to operate in a so-called retail mode in which only certain functions are available. In this embodiment, the vehicle or TV can operate in a rental mode at 200, so that electronic devices in hotels and rental cars can be placed into the rental mode.

In another embodiment, the rental device command can be received from the user device, e.g., smartphone shown as 201. In the embodiments, when the smartphone is connecting, the smartphone also attempts to detect if the connection is to a home device at 210. If not, the smartphone carries out certain operations, including sending a message to the installed device with which is communicating indicating that this is not a home device.

When the user is connecting their smartphone to an installed device, part of the pairing can include an indication that this is not a home device, thus forming another way in which the device can determine that it is not a home device pairing.

If the device determines that it is connecting to a home device, then pairing is normally carried out at 220.

If not, however, then a temporary pairing mode is set at 225. The temporary pairing mode can include functions to enhance the security of the pairing mode for temporary pairing situations.

In embodiments, as described herein, the installed device carries out an operation to detect if it is likely that the user device should no longer be paired. The operation requires receiving a still-paired signal from the user device that indicates whether the user device should still be paired.

In one embodiment, the still paired signal include setting a personal identification number, or PIN shown as 226 at a time of pairing. This PIN needs to be reentered at specified intervals. In one embodiment, the PIN needs to be reentered every time that the user device connects to the installed device after being disconnected. In another embodiment, this requires that PIN being entered at time intervals, for example the PIN may need to be reentered each calendar day to maintain the pairing, and otherwise, the pairing is terminated. In another device, the PIN needs to be entered every day after checkout time, for example, if 12:00 Noon is checkout time in the hotel, then the PIN needs to be entered every day in the afternoon to establish the connection.

In an embodiment, each calendar day, when the user attempts to connect, at the first connection, the device as “please enter your PIN”. At 227, the PIN is received, either from the smartphone itself, or from the user interface on the vehicle. If the PIN is entered and correct at 227, the process continues and the pairing is carried out. If the PIN is not correct, (or possibly not correct multiple times in a row), or the user presses cancel or some equivalent number on the device, then at 250, unpairing occurs, where the installed device unpairs and deletes all trace of the user device (e.g., the currently paired smartphone).

In another embodiment, a biometric, e.g., face or fingerprint, can be used instead of a PIN.

In one embodiment, the pairing can be used to display a user interface on the screen of the user device. For example, when Bluetooth pairing is used, the automobile or television set can send a user interface or commands for a user interface to the user device. This user interface or command for user interface then says, “please enter your PIN to keep connected to the Ford Mustang that you rented”. If the user enters the PIN, then the connection is renewed. If the user does not enter their PIN, or presses cancel, the pairing is reversed, and the installed device, here the Ford Mustang, deletes all record of the connection.

At 230, another still paired signal is used. This can be used in addition in addition to the PIN system or as an alternative. At 230, The installed device uses the connection, e.g. the Bluetooth connection, or a Wi-Fi connection that has been set up based on the Bluetooth connection, to determine the location of the user device. 231 determines if the user device is more than an “acceptable” distance (50 miles in this embodiment) from the installed device. If the user device moves more than 50 miles away from the installed device, then at 250, the unpairing operation is carried out which causes the installed device to unpair from the user device, and delete all trace of the user device, by removing it from the pairing list that is stored on the installed device.

In an embodiment, the minimum acceptable distance is longer than any short term communication range. For example, the acceptable distance needs to be longer than any Bluetooth or wifi signal. A minimum value of the acceptable distance needs to be, for example, at least ½ mile or at least a mile, so that simply being out of Bluetooth or wifi range will not automatically cause unpairing.

At 235, an additional pairing detection is carried out, where the system determines an amount of time since which the user has connected. If the user has not connected for more than one day, or some other time is that by the user, then flow passes to a query at 236 which questions the user about whether they want to maintain the pairing. For example, the question may say, you haven't connected to your Ford Mustang that you rented in the past day, do you want to maintain the pairing? If the user says no or does not answer, then the unpair routine at 250 to delete all traces of the user device.

The above has described this occurring on the installed device, however this consent also analogously occur on the user device. As described herein, the user device can also carry out these functions of location time and manual, and then send a unpaired command at 240 to the installed device. Since this may be received from the smartphone for example after the smartphone has left the area of the installed device, the unpaired command is typically received over the cellular network or the Wi-Fi network and again causes an unpair command from the device.

FIG. 2 shows this situation on the user device side, as a function that can be carried out in the user device, e.g. the smartphone. When the smartphone detects that is a not a home device at 210, and this may be as simple as the user saying “connect to a nonhome device”. A temporary pair mode is entered at 260. The smartphone may use the same analysis to determine to end the pairing, if it is more than 50 miles at 265, if more than a day has passed, or the user defines a manual unpairing. All of these can cause an unpair command, by sending an upair command to the connected device.

The smartphone allows pairing based on proximity and cause the connected vehicle to delete or refresh its memory once the paired smartphone was more than a certain distance away from the rental vehicle.

The system could utilize distance and tracking technology that already exists on smartphones such as GPS and cellular signal locator means. In this way, the smartphone and/or the rental vehicle, becomes an AirTag-like device. This time and/or distance data might allow for automatic unpairing and data deletion.

The system could also alert the user before making the unpairing and deleting any remaining memory. This could be based on time and/or distance factors.

For example, once a user returned their rental car at the San Diego Rental Car Facility, he or she would board a bus to the San Diego Airport. Perhaps enroute on the bus or upon arriving at the airport, their smartphone would give them a prompt such as: “It seems like you are no longer using the Hertz Tesla rental car, would you like to completely unpair and delete and remaining data?” The user could then accept or deny. If accepted, the smartphone would send a signal to the rental car to unpair and delete any stored data.

It is anticipated that this communication could occur directly between the user's smartphone and the vehicle or via a network managed by the rental car company. In this way, the user's smartphone would utilize the app or website of the rental car company to ensure that this disconnect, and data deletion takes place.

This technology would also be useful for smartphone users when they are riders. It would potentially prevent unwanted pairing or data sharing to the vehicle of the driver. This would secure the smartphone from unwanted pairing while being used in a ride-share environment such as Uber or Lyft.

The system would have many benefits for the user and the rental car company. These would include convenience, cost-savings, peace-of-mind and reduced liability from data stored in the vehicles.

The previous description of the disclosed exemplary embodiments is provided to enable any Personal skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A system, comprising:
an installed device which has a pairing ability which allows pairing to communicate with a wireless user device that is remote from the installed device;
a wireless user device, which wirelessly pairs with the installed device to allow communication with the remote wireless user device;
the installed device operating in a rental mode, to set a temporary pairing mode, and in the temporary pairing mode, the installed device receiving a still-paired signal from the wireless user device, wherein the still paired signal is a Personal Identification Number (PIN) that is received on the installed device from the wireless user device;
wherein when the PIN that is received matches to a stored pin in the installed device, the wireless user device remains electronically paired to the installed device, and the installed device continues to store information from the wireless user device, including stored information which enables the installed device to pair with the wireless user device at a future time, and also continues to store information from the wireless user device;
and wherein when the PIN that is received does not match to a stored pin in the installed device, the installed device removes all trace of the wireless user device from the installed device including the information from the wireless user device and including the stored information which enables the installed device to pair with the wireless user device at the future time.

2. (canceled)

3. A system, comprising:
an installed device which has a pairing ability which allows pairing to communicate with a wireless user device that is remote from the installed device;
a wireless user device, which wirelessly pairs with the installed device to allow communication with the remote wireless user device;
the installed device operating in a rental mode, to set a temporary pairing mode, and in the temporary pairing mode, the installed device receiving a signal indicative of a location of the wireless user device, and where the installed device determining a distance between the installed device and the wireless user device, and where when the installed device determines the distance between the installed device and the wireless user device being less than a specified distance that is at least ½ mile the installed device continues to store information from the wireless user device, including stored information which enables the installed device to pair with the wireless user device at a future time, and also continues to store information from the wireless user device;
and wherein when the installed device determines the distance being more than the specified distance the installed device removes all trace of the wireless user device from the installed device including the information from the wireless user device and including the stored information which enables the installed device to pair with the wireless user device at the future time.

4-6. (canceled)

7. System as in claim 1 wherein the installed device is a car, and the temporary pairing mode is set when the car is a rental car.

8. System as in claim 1, wherein the installed device is a television, and the temporary pairing mode is set when the television is in a rental situation.

9. A method, comprising providing an installed device which has a pairing ability which allows pairing to communicate with a wireless user device that is remote from the installed device;
providing a wireless user device, which wirelessly pairs with the installed device to allow communication with the remote wireless user device;
operating the installed device, to set a temporary pairing mode, and in the temporary pairing mode, the installed device receiving a still-paired signal from the wireless user device, wherein the still paired signal is a Personal Identification Number (PIN) that is received on the installed device from the wireless user device;
determining if the PIN that is received matches to a stored pin in the installed device, and if the PIN matches to the stored information, the installed device continues to store information from the wireless user device, including stored information which enables the installed device to pair with the wireless user device at a future time, and also continues to store information from the wireless user device;
and when the PIN that is received does not match to a stored pin in the installed device, the installed device removes all trace of the wireless user device from the installed device including the information from the wireless user device and including the stored information which enables the installed device to pair with the wireless user device at the future time.

10-16. (canceled)

17. A system, comprising
an installed device which has a pairing ability which allows pairing to communicate with a wireless user device that is remote from the installed device;
a wireless user device, which wirelessly pairs with the installed device to allow communication with the wireless user device;
the installed device operating in a rental mode, to set a temporary pairing mode, and in the temporary pairing mode, the installed device receiving a signal from the wireless user device indicating a location of the wireless user device;
where the installed device determines a distance between the installed device and the wireless user device,
where the installed device stores an acceptable distance between the installed device and the wireless user device, where the acceptable distance is a value greater than ½ mile;
where the installed device determines the distance being less than the acceptable distance and causes the wireless user device to remain paired to the installed device and to continue to store stored information from the wireless user device which enables the installed device to pair with the wireless user device at the future time and to store personal information from the wireless user device;
where the installed device determines the distance being greater than the acceptable distance and causes the wireless user device to unpair from the installed device, and to delete on the installed device, stored information which enables the installed device to pair with the wireless user device at the future time, and to delete the personal information from the wireless user device on the installed device.
